(19) United States
(12) Patent Application Publication
(10) Pub. No.: US 2020/0371225 A1
(43) Pub. Date: Nov. 26, 2020

(54) METHOD AND DEVICE FOR MEASURING DISTANCE BETWEEN WIRELESS NODES

(71) Applicant: TELINK SEMICONDUCTOR (SHANGHAI) CO., LTD., Shanghai (CN)

(72) Inventor: Haipeng JIN, Shanghai (CN)

(21) Appl. No.: 16/876,476

(22) Filed: May 18, 2020

(30) Foreign Application Priority Data
May 21, 2019 (CN) 201910423979.6

(51) Int. Cl. G01S 13/84; G01S 13/28; H04L 5/16

(52) U.S. Cl. CPC G01S 13/84; H04L 5/16; G01S 13/288

(57) ABSTRACT

The present invention provides a method and a device for measuring a distance between wireless nodes, the method comprises: performing, by a first wireless node I and a second wireless node R, a preset measurement of a phase difference in a preset half-duplex communication mode, based on a first operating frequency and a second operating frequency synchronously changed multiple times, to determine a first phase difference H₀ and a second phase difference H₁; and determining a distance between the first wireless node I and the second wireless node R by performing a differential operation of the first phase difference H₀ and the second phase difference H₁. According to the above method, there is no need for transceivers of the first wireless node I and the second wireless node R to work simultaneously, and a distance between wireless nodes may also be measured for the transceivers working in the half-duplex mode.

### CROSS-REFERENCE TO RELATED PATENT APPLICATION

This application claims the benefit of and priority to Chinese Patent Application No. 201910423979.6 filed on May 21, 2019, the entire disclosure of which is incorporated by reference herein.

### FIELD OF THE INVENTION

The present invention relates to the technical field of distance measurement, and in particular, to a method and a device for measuring a distance between wireless nodes based on active response.

### BACKGROUND OF THE INVENTION

This section is intended to provide background or context for the embodiments of the invention recited in the claims. The description here is not admitted to be prior art because it is included in this section.

In a traditional radar system, the distance measurement is usually done by transmitting by a transmitter a continuous radio wave, receiving by a receiver the radio wave bounced back from a measured object, and computing the phase difference between the transmitter and the receiver to estimate the distance to the target. However, this radar measurement method has the following problems: it is difficult to use a radar system to measure position in an indoor environment, and the transmitter and receiver need to use a full-duplex communication mode, that is, the phase difference is determined through simultaneous signal transmission and receiving.

Therefore, alternatively, the present application proposes a measurement of a distance between wireless nodes that only need to work in the half-duplex mode.

### SUMMARY OF THE INVENTION

As directed to the above mentioned problem that the radar ranging method in the prior art is difficult to perform indoor ranging and needs to use the full-duplex communication mode, the present invention is directed to a method and a device for measuring a distance between wireless nodes, which calculates a distance between two wireless nodes using the measurement results of active reflection, thereby being able to measuring a distance between wireless nodes working in the half-duplex mode.

The present invention provides the following solutions.

A method for measuring a distance between wireless nodes, comprising:

performing, by a first wireless node I and a second wireless node R, a preset measurement of a phase difference in a preset half-duplex communication mode, to determine a first phase difference H₀;

synchronously changing a first operating frequency of the first wireless node I and a second operating frequency of the second wireless node R based on a preset frequency difference value;

performing again, by the first wireless node I and the second wireless node R, the preset measurement of the phase difference in the preset half-duplex communication mode, based on the synchronously changed first operating frequency and second operating frequency, to determine a second phase difference H₁; and

determining the distance between the first wireless node I and the second wireless node R by performing a differential operation of the first phase difference H₀ and the second phase difference H₁.

Optionally, the preset measurement of the phase difference comprises:

generating and transmitting, by the first wireless node I, a first signal based on the first operating frequency;

mixing and receiving, by the second wireless node R, the first signal based on the second operating frequency, and measuring a phase difference between the first signal and a second local signal to determine a first value, wherein, the second local signal is generated by the second wireless node R based on the second operating frequency;

generating and transmitting, by the second wireless node R, a second signal based on the second operating frequency;

mixing and receiving, by the first wireless node I, the second signal based on the first operating frequency, and measuring a phase difference between the second signal and a first local signal to determine a second value, wherein, the first local signal is generated by the first wireless node I based on the first operating frequency; and

determining the first phase difference H₀ or the second phase difference H₁ from the first value and the second value;

wherein, the time when the first wireless node I starts transmitting the first signal is a first time point, the time when the second wireless node R starts transmitting the second signal is a second time point, and the time interval between the first time point and the second time point is fixed in advance.

Optionally, the first signal and the second signal are single frequency carrier signals.

Optionally, the first operating frequency is the same as the second operating frequency or differs by only frequency difference value of one intermediate frequency receiver.

Optionally, determining the first phase difference H₀ or the second phase difference H₁ from the first value and the second value specifically comprises:

determining the first phase difference H₀ from the first value and the second value in response to the first operating frequency and the second operating frequency before being changed; or,

determining the second phase difference H₁ from the first value and the second value in response to the changed first operating frequency and second operating frequency.

Optionally, during the period that the first wireless node I is switched from transmitting the first signal to receiving the second signal and during the period that the second wireless node R is switched from receiving the first signal to transmitting the second signal, a RF phase-locked loop is always turned on to maintain phase continuity.

Optionally, the differential operation specifically comprises:

determining the distance r between the first wireless node I and the second wireless node R by a formula r=c×(H₁−H₀)/4πΔf, wherein, c is the speed of light, Δf is the preset frequency difference value (the difference between the two first frequencies used when measuring H₀ and H₁).

Optionally, the method further comprises:

performing, by the first wireless node I and the second wireless node R, the preset measurement of the phase difference multiple times in the preset half-duplex communication mode, based on the first operating frequency and the second operating frequency synchronously changed multiple times, to determine the distance between the first wireless node I and the second wireless node R multiple times, thereby improving the accuracy of the measurement through the superposition of multiple measurements.

Optionally, the method further comprises:

connecting the first wireless node I and the second wireless node R through a short cable, in a laboratory environment;

performing, by the first wireless node I and the second wireless node R, the preset measurement of the phase difference repeatedly in the preset half-duplex communication mode, based on the first operating frequency and the second operating frequency before/after being synchronously changed, respectively, to determine a phase difference correction value; and

correcting the determined distance between the first wireless node I and the second wireless node R based on the phase difference correction value.

A device for measuring a distance between wireless nodes, comprising:

a first measurement module configured to perform, by a first wireless node I and a second wireless node R, a preset measurement of a phase difference in a preset half-duplex communication mode, to determine a first phase difference H₀;

a frequency changing module configured to synchronously change a first operating frequency of the first wireless node I and a second operating frequency of the second wireless node R based on a preset frequency difference value;

a second measurement module configured to perform again, by the first wireless node I and the second wireless node R, the preset measurement of the phase difference in the preset half-duplex communication mode, based on the synchronously changed first operating frequency and second operating frequency, to determine a second phase difference H₁; and

a distance determination module configured to determine the distance between the first wireless node I and the second wireless node R by performing a differential operation of the first phase difference H₀ and the second phase difference H₁.

Optionally, the first measurement module and/or the second measurement module are specifically configured to:

generate and transmit, by the first wireless node I, a first signal based on the first operating frequency;

mix and receive, by the second wireless node R, the first signal based on the second operating frequency, and measure a phase difference between the first signal and a second local signal to determine a first value, wherein, the second local signal is generated by the second wireless node R based on the second operating frequency;

generate and transmit, by the second wireless node R, a second signal based on the second operating frequency;

mix and receive, by the first wireless node I, the second signal based on the first operating frequency, and measure a phase difference between the second signal and a first local signal to determine a second value, wherein, the first local signal is generated by the first wireless node I based on the first operating frequency; and

determine the first phase difference H₀ or the second phase difference H₁ from the first value and the second value;

wherein, the time when the first wireless node I starts transmitting the first signal is a first time point, the time when the second wireless node R starts transmitting the second signal is a second time point, and the time interval between the first time point and the second time point is fixed in advance.

Optionally, the first signal and the second signal are single frequency carrier signals.

Optionally, the first operating frequency is the same as the second operating frequency or differs by only frequency difference value of one intermediate frequency receiver.

Optionally, the first measurement module and/or the second measurement module are specifically configured to:

determine the first phase difference H₀ from the first value and the second value in response to the first operating frequency and the second operating frequency before being changed; or,

determine the second phase difference H₁ from the first value and the second value in response to the changed first operating frequency and second operating frequency.

Optionally, during the period that the first wireless node I is switched from transmitting the first signal to receiving the second signal and during the period that the second wireless node R is switched from receiving the first signal to transmitting the second signal, a RF phase-locked loop is always turned on to maintain phase continuity.

Optionally, the distance determination module is specifically configured to:

determine the distance r between the first wireless node I and the second wireless node R by a formula r=c×(H₁−H₀)/4πΔf, wherein, c is the speed of light, Δf is the preset frequency difference value.

Optionally, the device is further configured to:

perform, by the first wireless node I and the second wireless node R, the preset measurement of the phase difference multiple times in the preset half-duplex communication mode, based on the first operating frequency and the second operating frequency synchronously changed multiple times, to determine the distance between the first wireless node I and the second wireless node R multiple times, thereby improving the accuracy of the measurement through the superposition of multiple measurements.

Optionally, the device further comprises a reference module configured to:

connect the first wireless node I and the second wireless node R through a short cable, in a laboratory environment;

perform, by the first wireless node I and the second wireless node R, the preset measurement of the phase difference repeatedly in the preset half-duplex communication mode, based on the first operating frequency and the second operating frequency before/after being synchronously changed, respectively, to determine a phase difference correction value; and

correct the determined distance between the first wireless node I and the second wireless node R based on the phase difference correction value.

The above at least one technical solution adopted in the embodiments of the present application can achieve the following beneficial effects: in the present invention, according to the technical solutions provided above, there is no need for transceivers of the first wireless node I and the second wireless node R to work simultaneously, a distance between wireless nodes may also be measured for the transceivers working in the half-duplex mode, and during the distance measurement, the first wireless node I and the second wireless node R may work at different operating frequencies.

It should be understood that, the above description only shows a summary of the technical solutions of the invention for better understanding the technical measures of the invention so as to implement the invention according to the contents of the disclosure. In order to make the above and other objects, characteristics and advantages of the invention more apparent, specific embodiments of the invention will be illustrated below by examples.

### BRIEF DESCRIPTION OF THE DRAWINGS

By reading the detailed description of the exemplary embodiments below, one of ordinary skills in the art will understand the above described and other advantages and benefits of the invention. The drawings are only provided for exhibiting exemplary embodiments, rather than limiting the invention. Throughout the drawings, the same labels are employed to indicate the same parts. In the drawings:

FIG. 1 is a schematic flowchart of a method for measuring a distance between wireless nodes according to an embodiment of the present invention;

FIG. 2 is a schematic diagram of communication between a first wireless node I and a second wireless node R according to an embodiment of the present invention;

FIG. 3 is a schematic flowchart of a method for measuring a distance between wireless nodes according to another embodiment of the present invention;

FIG. 4 is a schematic diagram of signals of the first wireless node I and the second wireless node R according to an embodiment of the invention;

FIG. 5 is a schematic structural diagram of a device for measuring a distance between wireless nodes according to an embodiment of the present invention; and

FIG. 6 is a schematic structural diagram of a device for measuring a distance between wireless nodes according to another embodiment of the present invention.

In the drawings, the same or corresponding labels indicate the same or corresponding parts.

### DETAILED DESCRIPTION OF THE EMBODIMENTS

Exemplary embodiments of the present invention will be described in detail below in conjunction with the drawings. Although exemplary embodiments of the invention are shown in the drawings, it should be understood that the invention may be implemented in various forms, rather than being limited to the embodiments illustrated herein. On the contrary, these embodiments are provided for more thoroughly understanding the invention and more fully convey the scope of the invention to those skilled in the art.

In the invention, it should be understood that, terms such as “include” or “comprise”, etc., indicate the existence of the characteristics, figures, steps, actions, components and parts disclosed in the invention or combinations thereof, without excluding the existence of one or more other characteristics, figures, steps, actions, components, parts or combinations thereof.

Additionally, it should be further noted that, the embodiments of the invention and the characteristics in the embodiments may be combined to each other in the case of no confliction. The invention will be illustrated in detail below referring to the drawings and in conjunction with the embodiments.

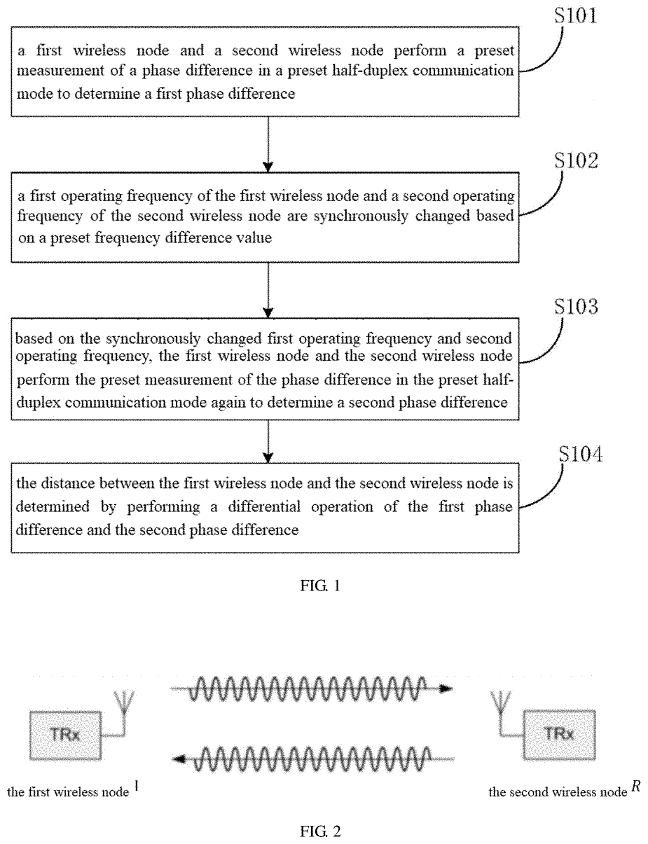

An embodiment of the present invention provides a method for measuring a distance between wireless nodes. FIG. 1 shows a flowchart of a method for measuring a distance between nodes according to an embodiment of the present invention. As shown in FIG. 1, the method includes but is not limited to Steps S101-S104. Specifically, the Steps include:

Step S101: a first wireless node I and a second wireless node R perform a preset measurement of a phase difference in a preset half-duplex communication mode, to determine a first phase difference H₀;

Step S102: a first operating frequency of the first wireless node I and a second operating frequency of the second wireless node R are synchronously changed based on a preset frequency difference value;

Specifically, in the process of changing the first operating frequency and the second operating frequency (f_{I}, f_{R}), a specified frequency difference value Δf is obtained, and a set of updated first operating frequency and second operating frequency (f′_{I}, f′_{R}) is obtained by the following formula:

f′_{R}=f_{R}+Δf, f′_{I}=f_{I}+Δf, or f′_{R}=f_{R}−Δf, f′_{I}=f_{I}−Δf.

Step S103: based on the synchronously changed first operating frequency and second operating frequency, the first wireless node I and the second wireless node R perform the preset measurement of the phase difference in the preset half-duplex communication mode again, to determine a second phase difference H₁;

Step S104: the distance between the first wireless node I and the second wireless node R is determined by performing a differential operation of the first phase difference H₀ and the second phase difference H₁.

Specifically, referring to FIG. 2, the first wireless node I and the second wireless node R are exemplarily shown, wherein the circuit structure of the first wireless node I is the same as the circuit structure of the second wireless node R, each of the first wireless node I and the second wireless node R is a transceiver TRx including a signal transmitting circuit TX and a signal receiving circuit RX. The half-duplex communication refers to a communication method that may achieve two-way communication, which cannot be performed in both directions simultaneously and has to be performed alternately. That is, in this embodiment, the first wireless node I and the second wireless node R may alternately perform the bidirectional signal transmission operation. Preferably, the time interval for alternate signal transmission is predetermined.

In addition, during the preset half-duplex communication process between the first wireless node I and the second wireless node R, the first wireless node I and the second wireless node R respectively perform signal transmission and reception operations at their respective operating frequencies. Specifically, in the two preset measurements of the phase difference in Steps S101 and S103, the first wireless node I performs signal transmission or reception operations at the operating frequency f_{I} and the operating frequency f′_{I}, respectively, and accordingly, the second wireless node R performs signal transmission or reception operations at the operating frequency f_{R} and the operating frequency f′_{R}, respectively. Wherein, in the operation of receiving a signal by the second wireless node R, since the second wireless node R has a phase-locked loop PLL, the phase of the undebugged carrier signal received by the second wireless node R may be subtracted from the phase of the local signal in the PLL in the phase detector PD, and then the phase differences P_{R} and P′_{R} may be obtained before and after changing the operating frequencies, respectively. After a fixed time interval, the second wireless node R performs signal transmission operations at the operating frequency f_{R} and the operating frequency, respectively. Accordingly, in the operation of receiving a signal by the first wireless node I, before and after the change of the operating frequencies, the first wireless node I may perform signal receiving operations at the operating frequency f_{I} and the operating frequency f′_{I}, respectively, where the first wireless node I also has a phase-locked loop PLL, so that the phase of the undebugged carrier signal received by the first wireless node I may be subtracted from the phase of the PLL in the phase detector PD, and then the phase differences P_{I} and P′_{I} are obtained. Wherein, f′_{I}−f_{I}=f′_{R}−f_{R}=Δf, that is, the first operating frequency and the second operating frequency are changed synchronously by the same frequency difference. In the present invention, the first operating frequency f′_{I} and the second operating frequency f′_{R} having the same frequency difference Δf from the original first operating frequency f_{I} and second operating frequency f_{R} are introduced, and then the half-duplex communication steps and the preset measurement of the phase difference are performed repeatedly. It can be understood that, since the phase differences P_{R}, P′_{R}, P_{I} and P′_{I} are linearly related to the measurement time, the time factor in the phase differences P_{R}, P′_{R}, P_{I} and P′_{I} may be removed by correspondingly designing the half-duplex communication switching process and the time points of preset measurement of the phase difference before and after changing the operating frequencies, and then the distance between the first wireless node I and the second wireless node R may be determined by performing a differential operation of the above phase differences P_{R}, P′_{R}, P_{I} and P′_{I} and the set Δf.

In this embodiment, distance measurement in a radio network with multiple nodes may be based on phase measurement. Wherein, in half-duplex communication, carrier signals having corresponding operating frequencies are transmitted alternately by two nodes, the phase of the wave received by the opposite node is analyzed and stored as a measured value, and then the operating frequencies of the two nodes are changed by the same frequency difference, the above communication and measurement process is repeated and the distance r between the stations may be calculated. In the present invention, according to the technical solutions provided above, there is no need for transceivers of the first wireless node I and the second wireless node R to work simultaneously, a distance between wireless nodes may also be measured for the transceivers working in the half-duplex mode, and during the distance measurement, the first wireless node I and the second wireless node R may work at different operating frequencies.

Based on the method for measuring a distance between wireless nodes in FIG. 1, some embodiments of the present application further provide some specific implementation solutions and extension solutions for the method for measuring a distance between wireless nodes, which will be described below.

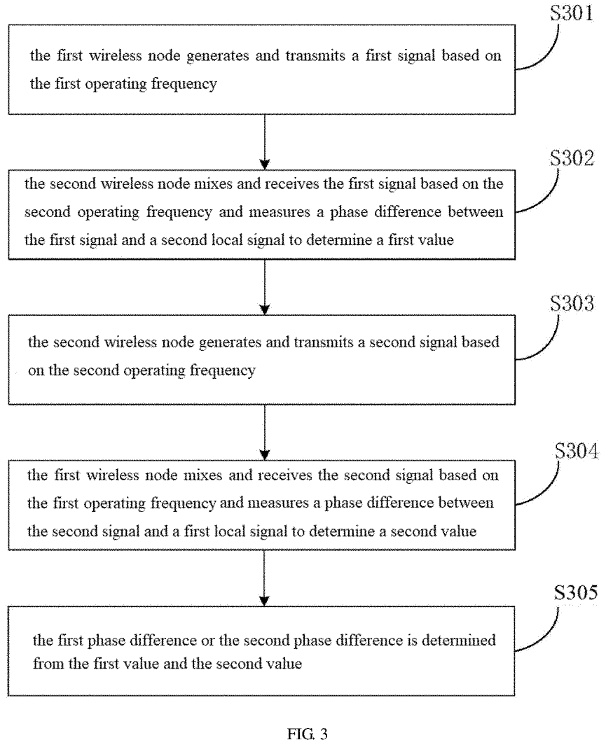

In an embodiment, further, as shown in FIG. 3 the first wireless node I and the second wireless node R performing the preset measurement of the phase difference in a preset half-duplex communication mode in Steps S101 and S103 specifically comprise the following Steps S301˜S305:

Step S301: the first wireless node I generates and transmits a first signal based on the first operating frequency;

Step S302: the second wireless node R mixes and receives the first signal based on the second operating frequency, and measures a phase difference between the first signal and a second local signal to determine a first value, wherein, the second local signal is generated by the second wireless node R based on the second operating frequency;

Step S303: the second wireless node R generates and transmits a second signal based on the second operating frequency;

Step S304: the first wireless node I mixes and receives the second signal based on the first operating frequency, and measures a phase difference between the second signal and a first local signal to determine a second value, wherein, the first local signal is generated by the first wireless node I based on the first operating frequency;

Step S305: the first phase difference H₀ or the second phase difference H₁ is determined from the first value and the second value;

wherein, the time when the first wireless node I starts transmitting the first signal is a first time point, the time when the second wireless node R starts transmitting the second signal is a second time point, and the time interval between the first time point and the second time point is fixed in advance.

In an embodiment, the first signal and the second signal are single frequency carrier signals. In an embodiment, the first operating frequency is the same as the second operating frequency or differs by only frequency difference value of one intermediate frequency receiver.

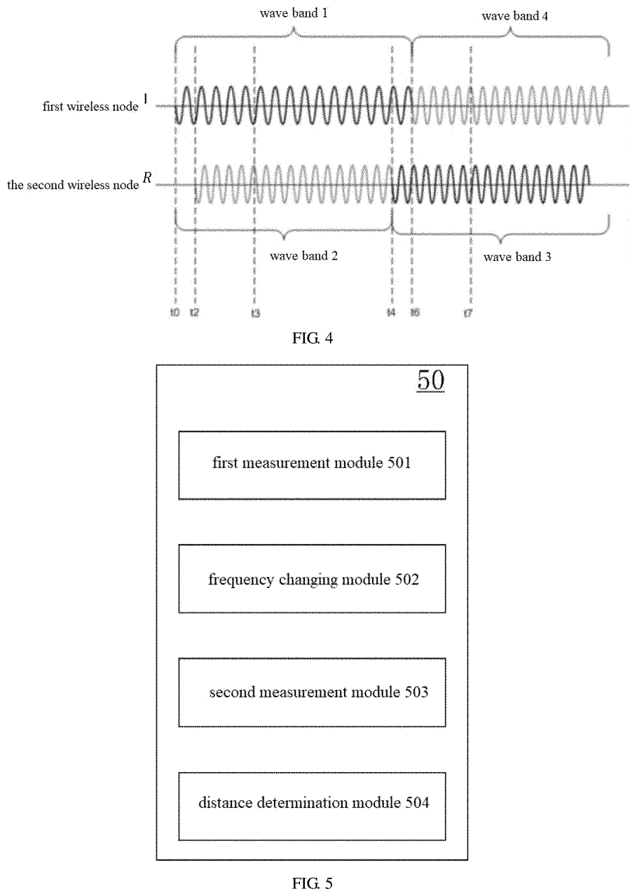

For example, referring to FIG. 4, the preset measurement of the phase difference before the change of the operating frequency is used as an example for description, wave band 1 shows Step S301, the first wireless node I generates and transmits a first signal based on the first operating frequency; wave band 2 shows Step S302, the second wireless node R receives the first signal based on the second operating frequency, wherein, at one or more predetermined measurement time points (for example, t₂), the second wireless node R performs phase comparison through the phase detector PD in the phase-locked loop PLL therein, so that the phase of the received undebugged carrier signal may be subtracted from the phase of the PLL in the phase detector PD to obtain the first value (phase measurement value) P_{R}; After a fixed time interval (for example, t₄−t₀), wave band 3 shows Step S303, the second wireless node R generates and transmits a second signal based on the second operating frequency, optionally, phase-locked loop may be used for phase locking to avoid the loss of phase continuity when switching between signal receiving and signal transmission; wave band 4 shows Step S304, the first wireless node I receives the second signal based on the first operating frequency, wherein, at another one or more predetermined measurement time points (for example, t₆), the first wireless node performs phase comparison through the phase detector PD in the phase-locked loop PLL therein, so that the phase of the received undebugged carrier signal may be subtracted from the phase of the PLL in the phase detector PD to obtain the second value (phase measurement value) P_{I}. Accordingly, after the change of the operating frequency, according to the same steps, the first value P′_{R} may be obtained by the second wireless node R, and the second value P′_{I} may be obtained by the first wireless node 1. Furthermore, the first phase difference H₀ or the second phase difference H₁ may be determined based on the first value and the second value.

In an embodiment, further, determining the first phase difference H₀ or the second phase difference H₁ from the first value and the second value in Step S305 specifically comprises:

determining the first phase difference H₀ from the first value and the second value in response to the preset operating frequency group before the change; or,

determining the second phase difference H₁ from the first value and the second value in response to the changed preset operating frequency group.

Specifically, for the first operating frequency f_{I} and the second operating frequency f_{R} before the change, the first phase difference H₀ is determined from the first value P_{R} and the second value P_{I} as: H₀=P_{R}+P_{I}. For the changed first operating frequency f′_{I} and second operating frequency f′_{R}, the second phase difference H₁ is determined from the first value P′_{R} and the second value P′_{I} as: H₁=P′_{R}+P′_{I}.

In an embodiment, further, during the period that the second wireless node R is switched from receiving the first signal to transmitting the second signal, a RF phase-locked loop is always turned on to maintain phase continuity.

It can be understood that the working principle of the phase-locked loop is to detect a phase difference between an input signal and an output signal, convert the detected phase difference signal into a voltage signal output through a phase detector, form a control voltage of a voltage-controlled oscillator after being filtered by a low-pass filter, control the frequency of the oscillator output signal, and then feedback the frequency and phase of the oscillator output signal to the phase detector through the feedback path. During the operation of the phase-locked loop, when the frequency of the output signal reflects the frequency of the input signal proportionally, the output voltage and the input voltage maintain a fixed phase difference, so that the phases of the output voltage and the input voltage are locked. Accordingly, phase continuity is not lost when switching between signal receiving and signal transmission.

In an embodiment, further, determining the distance between the first wireless node I and the second wireless node R from the first phase difference H₀ and the second phase difference H₁ in Step S104 specifically comprises:

determining the distance r between the first wireless node I and the second wireless node R by a formula r=c×(H₁−H₎)/4πΔf, wherein, c is the speed of light, Δf is the preset frequency difference value.

Specifically, referring to FIG. 4, according to the phase formula 2πft+Ø, it can be known that the phases of the first wireless node I and the second wireless node R can be expressed as: 2πf_{I}t+Ø_{I}, 2πf_{R}t+Ø_{R}, respectively, further, the theoretical derivation process of each phase difference operation is as follows:

(1) the phase difference calculation is performed at measurement point t₂;

Wherein, the phase of the first signal having the first operating frequency transmitted from the first wireless node I is: 2πf_{I}t₀+Ø_{I};

The phase of the second local signal generated by the second wireless node R is: 2πf_{R}t₂+Ø_{R}, which can be further extended to:

$$2 π {f}_{R} {t}_{0} + 2 π {f}_{R} \frac{r}{c} + 2 π {f}_{R} ( {D}_{It} + {D}_{Rr} ) + {∅}_{R} .$$

In summary, the phase difference P_{R} between the first signal and the second local signal may be determined by the following formula (a):

$${P}_{R} = 2 π ( {f}_{R} - {f}_{I} ) {t}_{0} + 2 π {f}_{R} \frac{r}{c} + 2 π {f}_{R} ( {D}_{It} + {D}_{Rr} ) + {∅}_{R} - {∅}_{I} \qquad ( a )$$

Wherein, f_{I} is the first operating frequency, f_{R} is the second operating frequency, t₀ is a time point when the first wireless node I transmits the first signal based on the first operating frequency, r is the distance between the first wireless node I and the second wireless node R, c is the speed of light, D_{It} is a hardware delay when the first wireless node I transmits the first signal, D_{Rr} is a hardware delay when the second wireless node R receives the first signal, Ø_{R} is the initial phase of the signal on the second wireless node R side, and Ø_{I} is the initial phase of the signal on the first wireless node I side.

(2) the phase difference calculation is performed at measurement point t₆;

Similarly, the phase difference P_{I} between the second signal and the first local signal may be determined by the following formula (b):

$${P}_{I} = 2 π ( {f}_{I} - {f}_{R} ) {t}_{4} + 2 π {f}_{I} \frac{r}{c} + 2 π {f}_{I} ( {D}_{Rt} + {D}_{Ir} ) - {∅}_{R} + {∅}_{I} + Δ {θ}_{IR} \qquad ( b )$$

Wherein, f_{I} is the value of the first operating frequency, f_{R} is the value of the second operating frequency, t₄ is a time point when the second wireless node R transmits the second signal, r is the distance between the first wireless node I and the second wireless node R, c is the speed of light, D_{It} is a hardware delay when the first wireless node I receives the second signal, D_{Rr} is a hardware delay when the second wireless node R transmits the second signal, Ø_{R} is the initial phase of the signal on the second wireless node R side, Ø_{I} is the initial phase of the signal on the first wireless node I side, and Δθ_{IR} is the phase error.

(3) the first phase difference H₀ is determined as:

$${H}_{0} = {P}_{R} + {P}_{I} = \frac{2 π ( {f}_{R} + {f}_{I} ) r}{c} + 2 π ( {f}_{I} - {f}_{R} ) ( {t}_{4} - {t}_{0} ) + 2 π {f}_{R} ( {D}_{It} + {D}_{Rr} ) + 2 π {f}_{I} ( {D}_{Rt} + {D}_{Ir} ) + Δ {θ}_{IR} \qquad ( c )$$

(4) Similarly, the second phase difference H₁ is determined by using the same method as the above-mentioned derivation processes (1) to (3) as:

$${H}_{1} = {P}_{R}^{′} + {P}_{I}^{′} = \frac{2 π ( {f}_{R}^{′} + {f}_{I}^{′} ) r}{c} + 2 π ( {f}_{I}^{′} + {f}_{R}^{′} ) ( {t}_{4} - {t}_{0} ) + 2 π {f}_{R}^{′} ( {D}_{It} + {D}_{Rr} ) + 2 π {f}_{I}^{′} ( {D}_{Rt} + {D}_{Ir} ) + Δ {θ}_{IR}^{′} \qquad ( d )$$

(5) the following operation may be performed based on the first phase difference H₀ and the second phase difference H₁ obtained above:

$${H}_{10} = {H}_{1} - {H}_{0} = 4 πΔ f \frac{r}{c} + 2 πΔ f ( {D}_{It} + {D}_{Rr} + {D}_{Rt} + {D}_{Ir} ) + Δ {θ}_{IR}^{′} - {Δθ}_{IR} \qquad ( e )$$

Further, the hardware delay (D_{It}+D_{Rr}+D_{Rt}+D_{Ir}) may be integrated into D, the phase error Δθ_{IR}′−Δθ_{IR} may be integrated into Δθ, and the above formula may be simplified to:

$${H}_{10} = {H}_{1} - {H}_{0} = 4 π Δ f \frac{r}{c} + 2 πΔ fD + Δθ \qquad ( f )$$

Since the value of the phase error Δθ is very small, the value of the hardware delay D can be obtained through pre-measurement, so a formula can be obtained:

r=c×(H₁−H₀−2πΔfD)/4πΔf (g)

In the present invention, H₁ and H₀ in the above formula (g) are obtained after calculation based on the measured values P_{R} and P_{I}, P′_{R} and P′_{I}, respectively, the speed of light c, the preset frequency difference value Δf and the hardware delay D are all known parameters, and thus, the distance between the first wireless node I and the second wireless node R may be obtained according to the above formula.

In an embodiment, further, in order to obtain more accurate measurement results and reduce measurement errors, the method further comprises:

performing, by the first wireless node I and the second wireless node R, the preset measurement of the phase difference multiple times in the preset half-duplex communication mode, based on the first operating frequency and the second operating frequency synchronously changed multiple times, to determine the distance between the first wireless node I and the second wireless node R multiple times.

Specifically, the first operating frequency of the first wireless node I and the second operating frequency of the second wireless node R may be synchronously changed multiple times according to another one or more preset frequency difference values, and then the first wireless node I and the second wireless node R repeat the steps such as S101 to S104 multiple times based on the first operating frequency and second operating frequency after each change, for example, the third phase difference H₃ and the fourth phase difference H₄ are obtained based on another preset frequency difference value Δf′, and then the distance r′ is determined by the formula r′=c×(H₄−H₃−2πΔf′D)/4πΔf′. Furthermore, the distance between the first wireless node I and the second wireless node R is finally determined according to the average value of r′ and r. It can be understood that through the superposition of multiple measurements, the above multiple measurements can obtain a measurement result with higher accuracy.

In an embodiment, since phase errors and hardware errors are unavoidable in all measurements. Further, this embodiment further proposes a method for reducing errors based on the distance measurement method shown in FIG. 1. The method further comprises:

connecting the first wireless node I and the second wireless node R through a short cable, in a laboratory environment;

performing, by the first wireless node I and the second wireless node R, the preset measurement of the phase difference repeatedly, based on the first operating frequency and the second operating frequency before/after being synchronously changed, respectively, to determine a phase difference correction value; and

correcting the determined distance between the first wireless node I and the second wireless node R based on the phase difference correction value.

Theoretically, it can be seen from the above formula (f), after performing the preset phase difference operation as described above, the first wireless node I and the second wireless node R that perform half-duplex communication through a short cable can determine ΔH as:

$$Δ H = 4 π Δ f \frac{{r}^{′}}{c} + 2 πΔ fD + Δθ \qquad ( h )$$

Wherein, r′ is the distance of the short cable communication, Δf is the preset frequency difference value, Δθ is the phase error, and D is the hardware error.

It can be understood that since the distance r′ during the short cable communication is extremely small relative to the speed of light c,

$$4 πΔ f \frac{{r}^{′}}{c}$$

may be ignored, and ΔH=2πΔfD+Δθ may be used as the phase difference correction value. Furthermore, the determined distance between the first wireless node I and the second wireless node R is corrected according to the phase difference correction value, and the phase error and hardware error may be corrected by a simple calculation step and a very small calculation amount.

FIG. 5 is a schematic structural diagram of a device for measuring a distance between wireless nodes, which device is used for preforming a method for measuring a distance between wireless nodes as shown in FIG. 1. Referring to FIG. 5, the device 50 specifically comprises:

a first measurement module 501 configured to perform, by a first wireless node I and a second wireless node R, a preset measurement of a phase difference during a half-duplex communication between the first wireless node I and the second wireless node R, to determine a first phase difference H₀;

a frequency changing module 502 configured to synchronously change a first operating frequency of the first wireless node I and a second operating frequency of the second wireless node R based on a preset frequency difference value;

a second measurement module 503 configured to perform again, by the first wireless node I and the second wireless node R, the preset measurement of the phase difference, based on the synchronously changed first operating frequency and second operating frequency, to determine a second phase difference H₁; and

a distance determination module 504 configured to determine the distance between the first wireless node I and the second wireless node R by performing a differential operation of the first phase difference H₀ and the second phase difference H₁.

In this embodiment, distance measurement in a radio network with multiple nodes may be based on phase measurement. Wherein, in half-duplex communication, carrier signals having corresponding operating frequencies are transmitted alternately by two nodes, the phase of the wave received by the opposite node is analyzed and stored as a measured value, and then the operating frequencies of the two nodes are changed by the same frequency difference, the above communication and measurement process is repeated and the distance r between the stations may be calculated. In the present invention, according to the technical solutions provided above, there is no need for transceivers of the first wireless node I and the second wireless node R to work simultaneously, a distance between wireless nodes may also be measured for the transceivers working in the half-duplex mode, and during the distance measurement, the first wireless node I and the second wireless node R may work at different operating frequencies, thus the measurement requirement is low.

Based on the device for measuring a distance between wireless nodes in FIG. 5, some embodiments of the present application further provide some specific implementation solutions and extension solutions for the device for measuring a distance between wireless nodes, which will be described below.

Optionally, the first measurement module and/or the second measurement module are specifically configured to:

generate and transmit, by the first wireless node I, a first signal based on the first operating frequency;

mix and receive, by the second wireless node R, the first signal based on the second operating frequency, and measure a phase difference between the first signal and a second local signal to determine a first value, wherein, the second local signal is generated by the second wireless node R based on the second operating frequency;

generate and transmit, by the second wireless node R, a second signal based on the second operating frequency;

mix and receive, by the first wireless node I, the second signal based on the first operating frequency, and measure a phase difference between the second signal and a first local signal to determine a second value, wherein, the first local signal is generated by the first wireless node I based on the first operating frequency; and

determine the first phase difference H₀ or the second phase difference H₁ from the first value and the second value;

wherein, the time when the first wireless node I starts transmitting the first signal is a first time point, the time when the second wireless node R starts transmitting the second signal is a second time point, and the time interval between the first time point and the second time point is fixed in advance.

Optionally, the first signal and the second signal are single frequency carrier signals.

Optionally, the first operating frequency is the same as the second operating frequency or differs by only frequency difference value of one intermediate frequency receiver.

Optionally, the first measurement module and/or the second measurement module are specifically configured to:

determine the first phase difference H₀ from the first value and the second value in response to the first operating frequency and the second operating frequency before being changed; or,

determine the second phase difference H₁ from the first value and the second value in response to the changed first operating frequency and second operating frequency.

Optionally, during the period that the first wireless node I is switched from transmitting the first signal to receiving the second signal and during the period that the second wireless node R is switched from receiving the first signal to transmitting the second signal, a RF phase-locked loop is always turned on to maintain phase continuity.

Optionally, the distance determination module is specifically configured to:

determine the distance r between the first wireless node I and the second wireless node R by a formula r=c×(H₁−H₀)/4πΔf, wherein, c is the speed of light, Δf is the preset frequency difference value.

Optionally, the device is further configured to:

perform, by the first wireless node I and the second wireless node R, the preset measurement of the phase difference multiple times in the preset half-duplex communication mode, based on the first operating frequency and the second operating frequency synchronously changed multiple times, to determine the distance between the first wireless node I and the second wireless node R multiple times, thereby improving the accuracy of the measurement through the superposition of multiple measurements.

Optionally, the device further comprises a reference module configured to:

connect the first wireless node I and the second wireless node R through a short cable, in a laboratory environment;

perform, by the first wireless node I and the second wireless node R, the preset measurement of the phase difference repeatedly in the preset half-duplex communication mode, based on the first operating frequency and the second operating frequency before/after being synchronously changed, respectively, to determine a phase difference correction value; and

correct the determined distance between the first wireless node I and the second wireless node R based on the phase difference correction value.

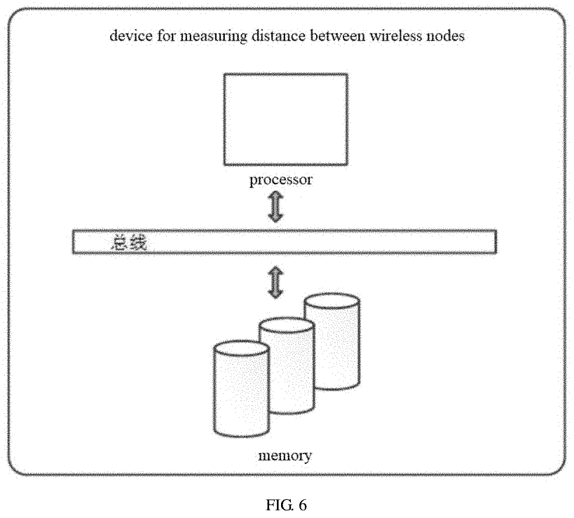

FIG. 6 is a schematic diagram of a device for measuring a distance between wireless nodes according to an embodiment of the present invention. The device comprises:

at least one processor; and

a memory connected to the at least one processor;

wherein, the memory stores instructions executable by the at least one processor, which instructions are executed by the at least one processor to enable the at least one processor to:

Step S101: perform, by a first wireless node I and a second wireless node R, a preset measurement of a phase difference in a preset half-duplex communication mode, to determine a first phase difference H₀;

Step S102: synchronously change a first operating frequency of the first wireless node I and a second operating frequency of the second wireless node R based on a preset frequency difference value;

Step S103: perform again, by the first wireless node I and the second wireless node R, the preset measurement of the phase difference in the preset half-duplex communication mode, based on the synchronously changed first operating frequency and second operating frequency, to determine a second phase difference H₁;

Step S104: determine the distance between the first wireless node I and the second wireless node R by performing a differential operation of the first phase difference H₀ and the second phase difference H₁.

According to some embodiments of the present application, there is provided a non-volatile computer storage medium for measuring a distance between wireless nodes corresponding to the above method for measuring a distance between wireless nodes, on which computer executable instructions are stored, when run by the processor, the computer executable instructions are set to:

Step S101: perform, by a first wireless node I and a second wireless node R, a preset measurement of a phase difference in a preset half-duplex communication mode, to determine a first phase difference H₀;

Step S102: synchronously change a first operating frequency of the first wireless node I and a second operating frequency of the second wireless node R based on a preset frequency difference value;

Step S103: perform again, by the first wireless node I and the second wireless node R, the preset measurement of the phase difference in the preset half-duplex communication mode, based on the synchronously changed first operating frequency and second operating frequency, to determine a second phase difference H₁;

Step S104: determine the distance between the first wireless node I and the second wireless node R by performing a differential operation of the first phase difference H₀ and the second phase difference H₁.

All the embodiments in the specification are described in a progressive manner, the same or similar parts among the various embodiments can refer to each other, and the emphasis of each embodiment is different from other embodiments. In particular, as for the embodiments of device, equipment and computer readable storage medium, they are substantially similar to the embodiments of method, so the description is relatively simple, and the related parts refer to the illustration of the parts of the embodiments of method.

The device, equipment and computer readable storage medium provided in the embodiments of the present application correspond to the method in one-to-one correspondence. Therefore, the device, equipment and computer readable storage medium also have beneficial technical effects similar to their corresponding method. The beneficial technical effects of the method are described in detail above, therefore, the beneficial technical effects of the device, equipment and computer readable storage medium will not be repeated here.

Those skilled in the art shall appreciate that the embodiments of the invention can be embodied as a method, a system or a computer program product. Therefore the invention can be embodied in the form of an all-hardware embodiment, an all-software embodiment or an embodiment of software and hardware in combination. Furthermore the invention can be embodied in the form of a computer program product embodied in one or more computer useable storage mediums (including but not limited to a disk memory, a CD-ROM, an optical memory, etc.) in which computer useable program codes are contained.

The invention has been described in a flow chart and/or a block diagram of the method, the device (system) and the computer program product according to the embodiments of the invention. It shall be appreciated that respective flows and/or blocks in the flow chart and/or the block diagram and combinations of the flows and/or the blocks in the flow chart and/or the block diagram can be embodied in computer program instructions. These computer program instructions can be loaded onto a general-purpose computer, a specific-purpose computer, an embedded processor or a processor of another programmable data processing device to produce a machine so that the instructions executed on the computer or the processor of the other programmable data processing device create means for performing the functions specified in the flow(s) of the flow chart and/or the block(s) of the block diagram.

These computer program instructions can also be stored into a computer readable memory capable of directing the computer or the other programmable data processing device to operate in a specific manner so that the instructions stored in the computer readable memory create an article of manufacture including instruction means which perform the functions specified in the flow(s) of the flow chart and/or the block(s) of the block diagram.

These computer program instructions can also be loaded onto the computer or the other programmable data processing device so that a series of operational steps are performed on the computer or the other programmable data processing device to create a computer implemented process so that the instructions executed on the computer or the other programmable device provide steps for performing the functions specified in the flow(s) of the flow chart and/or the block(s) of the block diagram.

In a typical configuration, the computing device includes one or more processors (CPUs), input/output interfaces, network interfaces and memory.

Memory may include non-permanent memory, random access memory (RAM) and/or non-volatile memory in computer-readable media, such as read only memory (ROM) or flash memory (flash RAM). Memory is an example of computer-readable media.

Computer-readable media, including permanent and non-permanent, removable and non-removable media, may store information by any method or technology. The information may be computer readable instructions, data structures, modules of programs, or other data. Examples of computer storage media include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technologies, read-only compact disc read-only memory (CD-ROM), digital versatile disc (DVD) or other optical storage, magnetic tape cassettes, magnetic tape magnetic disk storage or other magnetic storage devices or any other non-transmission media, for storing information that may be accessed by computing devices.

It should also be noted that the term “comprise”, “contain” or any other variant is intended to encompass the non-exclusive inclusion, so that the process, method, commodity or equipment including a series of elements not only includes those elements, but also includes other elements which are not listed clearly or includes the elements inherent in such process, method, commodity or equipment. Without more restrictions, the element defined by the sentence “include a . . . ” does not preclude the existence of another identical element in the process, method, commodity or equipment including the element.

The above are only embodiments of the present application and are not intended to limit the present application. For those skilled in the art, the present application may have various modifications and changes. Any modification, equivalent replacement, improvement, etc. made within the spirit and principle of the present application shall be included in the scope of the claims of the present application.

What is claimed is:

1. A method for measuring a distance between wireless nodes, comprising:
performing, by a first wireless node I and a second wireless node R, a preset measurement of a phase difference in a preset half-duplex communication mode, to determine a first phase difference H₀;
synchronously changing a first operating frequency of the first wireless node I and a second operating frequency of the second wireless node R based on a preset frequency difference value;
performing again, by the first wireless node I and the second wireless node R, the preset measurement of the phase difference in the preset half-duplex communication mode, based on the synchronously changed first operating frequency and second operating frequency, to determine a second phase difference H₁; and
determining the distance between the first wireless node I and the second wireless node R by performing a differential operation of the first phase difference H₀ and the second phase difference H₁.

2. The method according to claim 1, wherein, the preset measurement of the phase difference comprises:
generating and transmitting, by the first wireless node I, a first signal based on the first operating frequency;
mixing and receiving, by the second wireless node R, the first signal based on the second operating frequency, and measuring a phase difference between the first signal and a second local signal to determine a first value, wherein, the second local signal is generated by the second wireless node R based on the second operating frequency;
generating and transmitting, by the second wireless node R, a second signal based on the second operating frequency;
mixing and receiving, by the first wireless node I, the second signal based on the first operating frequency, and measuring a phase difference between the second signal and a first local signal to determine a second value, wherein, the first local signal is generated by the first wireless node I based on the first operating frequency; and
determining the first phase difference H₀ or the second phase difference H₁ from the first value and the second value;
wherein, the time when the first wireless node I starts transmitting the first signal is a first time point, the time when the second wireless node R starts transmitting the second signal is a second time point, and the time interval between the first time point and the second time point is fixed in advance.

3. The method according to claim 2, wherein, the first signal and the second signal are single frequency carrier signals.

4. The method according to claim 2, wherein, the first operating frequency is the same as the second operating frequency or differs by only frequency difference value of one intermediate frequency receiver.

5. The method according to claim 2, wherein, determining the first phase difference H₀ or the second phase difference H₁ from the first value and the second value specifically comprises:
determining the first phase difference H₀ from the first value and the second value in response to the first operating frequency and the second operating frequency before being changed; or,
determining the second phase difference H₁ from the first value and the second value in response to the changed first operating frequency and second operating frequency.

6. The method according to claim 2, wherein, during the period that the first wireless node I is switched from transmitting the first signal to receiving the second signal and during the period that the second wireless node R is switched from receiving the first signal to transmitting the second signal, a RF phase-locked loop is always turned on to maintain phase continuity.

7. The method according to claim 1, wherein, the differential operation specifically comprises:
determining the distance r between the first wireless node I and the second wireless node R by a formula r=c×(H₁−H₀)/4πΔf, wherein, c is the speed of light, Δf is the preset frequency difference value.

8. The method according to claim 1, further comprising:
performing, by the first wireless node I and the second wireless node R, the preset measurement of the phase difference multiple times in the preset half-duplex communication mode, based on the first operating frequency and the second operating frequency synchronously changed multiple times, to determine the distance between the first wireless node I and the second wireless node R multiple times, thereby improving the accuracy of the measurement through the superposition of multiple measurements.

9. The method according to claim 1, further comprising:
connecting the first wireless node I and the second wireless node R through a short cable, in a laboratory environment;
performing, by the first wireless node I and the second wireless node R, the preset measurement of the phase difference repeatedly in the preset half-duplex communication mode, based on the first operating frequency and the second operating frequency before/after being synchronously changed, respectively, to determine a phase difference correction value; and
correcting the determined distance between the first wireless node I and the second wireless node R based on the phase difference correction value.

10. A device for measuring a distance between wireless nodes, comprising:
a first measurement module configured to perform, by a first wireless node I and a second wireless node R, a preset measurement of a phase difference in a preset half-duplex communication mode, to determine a first phase difference H₀;
a frequency changing module configured to synchronously change a first operating frequency of the first wireless node I and a second operating frequency of the second wireless node R based on a preset frequency difference value;
a second measurement module configured to perform again, by the first wireless node I and the second wireless node R, the preset measurement of the phase difference in the preset half-duplex communication mode, based on the synchronously changed first operating frequency and second operating frequency, to determine a second phase difference H₁; and
a distance determination module configured to determine the distance between the first wireless node I and the second wireless node R by performing a differential operation of the first phase difference H₀ and the second phase difference H₁.

11. The device according to claim 10, wherein, the first measurement module and/or the second measurement module are specifically configured to:
generate and transmit, by the first wireless node I, a first signal based on the first operating frequency;
mix and receive, by the second wireless node R, the first signal based on the second operating frequency, and measure a phase difference between the first signal and a second local signal to determine a first value, wherein, the second local signal is generated by the second wireless node R based on the second operating frequency;
generate and transmit, by the second wireless node R, a second signal based on the second operating frequency;
mix and receive, by the first wireless node I, the second signal based on the first operating frequency, and measure a phase difference between the second signal and a first local signal to determine a second value, wherein, the first local signal is generated by the first wireless node I based on the first operating frequency; and
determine the first phase difference H₀ or the second phase difference H₁ from the first value and the second value;
wherein, the time when the first wireless node I starts transmitting the first signal is a first time point, and the time when the second wireless node R starts transmitting the second signal is a second time point, the time interval between the first time point and the second time point is fixed in advance.

12. The device according to claim 11, wherein, the first signal and the second signal are single frequency carrier signals.

13. The device according to claim 11, wherein, the first operating frequency is the same as the second operating frequency or differs by only frequency difference value of one intermediate frequency receiver.

14. The device according to claim 11, wherein, the first measurement module and/or the second measurement module are specifically configured to:
determine the first phase difference H0 from the first value and the second value in response to the first operating frequency and the second operating frequency before being changed; or,
determine the second phase difference H₁ from the first value and the second value in response to the changed first operating frequency and second operating frequency.

15. The device according to claim 11, wherein, during the period that the first wireless node I is switched from transmitting the first signal to receiving the second signal and during the period that the second wireless node R is switched from receiving the first signal to transmitting the second signal, a RF phase-locked loop is always turned on to maintain phase continuity.

16. The device according to claim 10, wherein, the distance determination module is specifically configured to:
determine the distance r between the first wireless node I and the second wireless node R by a formula r=c×(H₁−H₀)/4πΔf, wherein, c is the speed of light, Δf is the preset frequency difference value.

17. The device according to claim 10, wherein, the device is further configured to:
perform, by the first wireless node I and the second wireless node R, the preset measurement of the phase difference multiple times in the preset half-duplex communication mode, based on the first operating frequency and the second operating frequency synchronously changed multiple times, to determine the distance between the first wireless node I and the second wireless node R multiple times, thereby improving the accuracy of the measurement through the superposition of multiple measurements.

18. The device according to claim 10, further comprising a reference module configured to:
connect the first wireless node I and the second wireless node R through a short cable, in a laboratory environment;
perform, by the first wireless node I and the second wireless node R, the preset measurement of the phase difference repeatedly in the preset half-duplex communication mode, based on the first operating frequency and the second operating frequency before/after being synchronously changed, respectively, to determine a phase difference correction value; and
correct the determined distance between the first wireless node I and the second wireless node R based on the phase difference correction value.
